(19) United States
(12) Patent Application Publication
(10) Pub. No.: US 2026/0115921 A1
(43) Pub. Date: Apr. 30, 2026

(54) PALLETIZING SAFETY CONTROL AREA SETTING METHOD

(71) Applicant: BRILS Co., Ltd., Incheon (KR)

(72) Inventor: Jin JEON, Incheon (KR)

(21) Appl. No.: 18/945,228

(22) Filed: Nov. 12, 2024

(30) Foreign Application Priority Data
Oct. 30, 2024 (KR) 10-2024-0151251

(51) Int. Cl. B25J 9/16; B25J 15/06; B65G 43/00; B65G 61/00

(52) U.S. Cl. CPC B25J 9/1676; B25J 9/1697; B25J 15/0616; B65G 43/00; B65G 61/00

(57) ABSTRACT

According to an embodiment, there is provided a palletizing safety control area setting method implemented to prevent occurrence of safety accidents by displaying a safety area in a projection type around a logistics transport and loading system. The method includes safety area reading for reading the safety area corresponding to a range for preventing a collision with a transport robot forming the logistics transport and loading system to transport and load a transport object or the transport object under transportation and loading, from a safety area reading device, and safety area displaying for displaying the safety area read in the safety area reading, through projection of a projection device.

### CROSS REFERENCE TO RELATED APPLICATION

This application claims priority from Republic of Korea Patent Application No. 10-2024-0151251, filed on Oct. 30, 2024, which is hereby incorporated by reference in its entirety.

### BACKGROUND

### Field

The present disclosure relates to a palletizing safety control area setting method, and more specifically, relates to a palletizing safety control area setting method implemented to prevent occurrence of safety accidents by displaying a safety area in a projection type around a logistics transport and loading system.

### Description of Related Art

In modern logistics and manufacturing systems, transport robots are widely used to automatically transport and load transport objects having various sizes and weights. Transport robots have an advantage in that the transport robots can move articles along a set path and can load the articles at an accurate location without worker's intervention. However, in an automated environment, there is an extremely high probability that the transport robots collide with workers, obstacles, or other robots along movement paths of the transport robots and at locations where the transport objects are loaded. Consequently, serious safety problems may be caused in a logistics field.

In order to prevent such collision accidents, it is necessary to build a system in which safety areas are set up around the movement paths of the robots, and the safety areas are monitored on a real-time basis to immediately cope with a risk of collision when the risk of collision is detected. In particular, when there is an increasing risk that the transport objects fall down due to changes in positions or the center of gravity of the transport objects while the transport objects are transported, it is important to read the risk on a real-time basis to widen the safety areas, and to adjust a transport speed or a transport path when necessary, and to prevent collisions with workers in advance.

In addition, it is necessary to use advanced recognition devices such as 3D vision cameras to track locations and movements of the workers on a real-time basis, and to cope with the risk of collision by setting up avoidance maneuver areas in cases where the risk of collision is high.

Meanwhile, the above-described background technology is technical information owned by the inventor to derive the present disclosure or acquired by the inventor in a process of deriving the present disclosure, and cannot necessarily be a publicly known technology disclosed to the general public prior to an application of the present disclosure.

The present disclosure is a result of the Korea Patent Strategy Development Institute's government-led R&D full-cycle IP solution support project (Contract No. 24CC01P033).

Patent Document 0001: Korean Patent No. 10-2422251 (Published on July 19, 2022) and Patent Document 0002: Korean Patent No. 10-1779296 (Published on September 26, 2017) are examples in the related art.

### SUMMARY

One aspect of the present disclosure is to provide a palletizing safety control area setting method in which a probability of collision between a transport robot and a transport object is monitored on a real-time basis during a transport and loading process of the transport object, a safety area is dynamically set depending on characteristics of the transport object and surrounding environmental conditions, and the safety area is displayed in a projection type to prevent a collision.

A technical aspect of the present disclosure is not limited to the above-described technical aspect, and other technical aspects not described herein will be clearly understood by those skilled in the art from the description below.

According to one embodiment of the present disclosure, there is provided a palletizing safety control area setting method implemented to prevent occurrence of safety accidents by displaying a safety area in a projection type around a logistics transport and loading system. The method includes safety area reading for reading the safety area corresponding to a range for preventing a collision with a transport robot forming the logistics transport and loading system to transport and load a transport object or the transport object during transporting and loading, from a safety area reading device, and safety area displaying for displaying the safety area read in the safety area reading, through projection of a projection device.

In one embodiment, the safety area reading may include reading the safety area in view of a probability of collision between the transport robot and a worker or an obstacle existing within a movement rage of the transport robot.

In one embodiment, the safety area reading may include reading the safety area in view of a probability of collision between the transport object under transportation after the transport object is picked up by the transport robot and a worker or an obstacle existing within a movement rage of the transport robot.

In one embodiment, the safety area displaying may include reading the safety area in view of transport object characteristics including a size and a shape of the transport object under transportation after the transport object is picked up by the transport robot.

In one embodiment, the safety area displaying may include displaying the safety area in view of transport object characteristics read in the safety area reading.

In one embodiment, the transport object characteristics may be read, based on 3D vision recognition using a 3D vision camera.

In one embodiment, the palletizing safety control area setting method according to one embodiment of the present disclosure may further include avoidance maneuver area reading for reading an avoidance maneuver area which is an area avoided to prevent the collision by the transport robot when it is determined that the collision with the transport robot or the transport object occurs while the transport object is transported.

In one embodiment, the palletizing safety control area setting method according to one embodiment of the present disclosure may further include avoidance maneuver area displaying for displaying the avoidance maneuver area read in avoidance maneuver area reading, through projection of the projection device.

In one embodiment, the avoidance maneuver area displaying may include emphasizing and displaying the avoidance maneuver area to distinguish the safety area displayed in the safety area displaying and the avoidance maneuver area from each other.

In one embodiment, the palletizing safety control area setting method according to one embodiment of the present disclosure may further include area recognizing for recognizing the safety area displayed in the safety area displaying, through vision recognition.

In one embodiment, the palletizing safety control area setting method according to one embodiment of the present disclosure may further include risk level reading for reading a risk level of each of a plurality of the safety areas read in the safety area reading, based on recognition information recognized in the area recognizing, and differential monitoring for differentially monitoring the plurality of the safety areas in accordance with the risk level of the safety area read in the risk level reading.

In one embodiment, the palletizing safety control area setting method according to one embodiment of the present disclosure may further include probability of falling-down reading for reading a probability of falling-down of the transport object under transportation.

In one embodiment, the probability of falling-down reading includes reading the probability of falling-down of the transport object fastened to a gripping portion provided in the transport robot in view of at least one factor among a suction pressure distribution of each of a plurality of suction cups installed in an n*n row along a bottom surface of the gripping portion to fasten the transport object by using a position of the center of gravity and a negative pressure of the transport object fastened to the gripping portion, a suction leak degree of the suction cups, and a surface texture of the transport object.

In one embodiment, in the safety area reading, the safety area is widely set as the probability of falling-down is higher in the probability of falling-down reading.

In one embodiment, the palletizing safety control area setting method according to one embodiment of the present disclosure may further include avoidance maneuvering for performing a collision avoidance maneuver of the transport robot, when it is determined that there is a probability of collision with the transport robot or the transport object under transportation.

In one embodiment, the palletizing safety control area setting method according to one embodiment of the present disclosure may further include skeleton analyzing for performing a skeleton analysis on all workers who carry out work through a surveillance camera in a factory, real-time tracking for reading a risk level of collision by tracking a position and a movement of each of the workers who carry out the work on a real-time basis, based on skeleton information analyzed through the skeleton analyzing, and risk level reflecting for reflecting the risk level of collision read in the real-time tracking when a transport speed of the transport object or the safety area is set.

According to one aspect of the present disclosure described above, while the transport robot transports and loads the transport object, the probability of collision between the transport object and the worker or the obstacle existing within the movement range of the transport robot is analyzed on a real-time basis, the safety area is set, and the safety area is displayed by using the projection device. Accordingly, the risk of collision can be effectively prevented.

In addition, when the transport robot moves after picking up the transport object, characteristics such as a weight, a size, and a shape of the transport object are analyzed in view of the probability of collision between the transport object and surrounding workers and obstacles, and thereafter, a proper safety area is set. Accordingly, safety accidents that may occur while the transport object is transported can be prevented.

Since shapes of the transport object and the workers are accurately recognized through 3D vision recognition, the safety area can be more precisely set, and the probability of falling-down that may occur during transportation can be read in advance. Accordingly, a collision prevention function can be strengthened by widely setting the safety area as the probability of falling-down is higher.

In addition, when the probability of collision is high, safety of the workers can be secured by setting the avoidance maneuver area in the transport robot and displaying the avoidance maneuver area to the workers on a real-time basis through the projection device. In this way, the present disclosure can improve safety and efficiency of a logistics system by detecting and coping with all safety issues that may occur during a movement of the transport robot and a loading process of the transport object on a real-time basis.

Advantageous effects of the present disclosure are not limited to the above-described advantageous effects, and the present disclosure may include various advantageous effects within the scope obvious to those skilled in the art from the contents described below.

### BRIEF DESCRIPTION OF THE DRAWING

FIG. 1 is a flowchart illustrating a palletizing safety control area setting method according to a first embodiment of the present disclosure.

FIG. 2 is a diagram showing a logistics transport and loading system controlled by the present disclosure.

FIG. 3 is a flowchart illustrating a palletizing safety control area setting method according to a second embodiment of the present disclosure.

FIG. 4 is a flowchart illustrating a palletizing safety control area setting method according to a third embodiment of the present disclosure.

FIG. 5 is a flowchart illustrating a palletizing safety control area setting method according to a fourth embodiment of the present disclosure.

FIG. 6 is a flowchart illustrating a palletizing safety control area setting method according to a fifth embodiment of the present disclosure.

FIG. 7 is a flowchart illustrating a palletizing safety control area setting method according to a sixth embodiment of the present disclosure.

FIGS. 8 and 9 are diagrams showing a schematic configuration of the logistics transport and loading system according to one embodiment of the present disclosure.

FIG. 10 is a perspective view showing a gripping portion connected to a robot arm according to one embodiment.

FIG. 11 is a diagram shown at an angle different from an angle in FIG. 10.

FIG. 12 is a diagram showing an internal configuration of the gripping portion in more detail by omitting some configurations of the gripping portion in FIG. 10.

FIG. 13 is a diagram showing a state where a gripping module moves in response to an operation of a first hydraulic module in the gripping portion in FIG. 12.

FIG. 14 is an enlarged view of a portion in FIG. 13.

FIG. 15 is a diagram shown at an angle different from an angle in FIG. 14.

FIG. 16 is a diagram expressing a state where the gripping portion according to one embodiment grips and suctions an object.

FIG. 17 is a drawing showing the gripping portion according to one embodiment.

FIG. 18 is a diagram showing examples in which the object is incorrectly fastened by a suction cup of the gripping portion.

FIG. 19 is a diagram showing examples in which the object is correctly fastened by the suction cup of the gripping portion.

FIG. 20 is a diagram showing examples of methods for fastening a transport object by using a transport robot.

FIG. 21 is a diagram showing a suction gripper in the related art.

### DETAILED DESCRIPTION

Detailed description of the present disclosure described below refers to the accompanying drawings that show specific embodiments for embodying the present disclosure. The embodiments will be described in sufficient detail to enable a person skilled in the art to embody the present disclosure. It should be understood that various embodiments of the present disclosure are not necessarily mutually exclusive even though the embodiments are different from each other. For example, with regard to one embodiment, specific shapes, structures, and characteristics which are described herein may be implemented in other embodiments without departing from the concept and the scope of the present disclosure. In addition, it should be understood that positions or disposition of individual components within each disclosed embodiment may be changed without departing from the concept and the scope of the present disclosure. Accordingly, the detailed description of the present disclosure described below is not taken in a limiting sense, and the scope of the present disclosure is limited only by the appended claims, along with the full scope equivalent to the appended claims, if the scope of the present disclosure is properly described. Like reference numerals in the drawings designate the same or similar functions in various aspects.

Hereinafter, preferred embodiments of the present disclosure will be described in more detail with reference to the drawings.

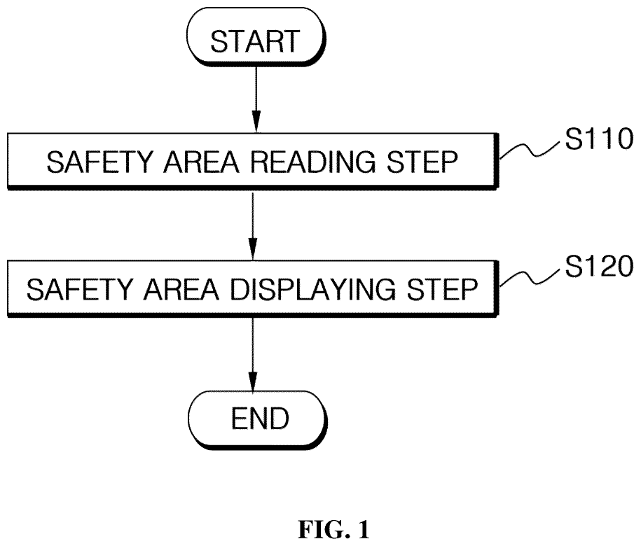

FIG. 1 is a flowchart illustrating a palletizing safety control area setting method according to a first embodiment of the present disclosure.

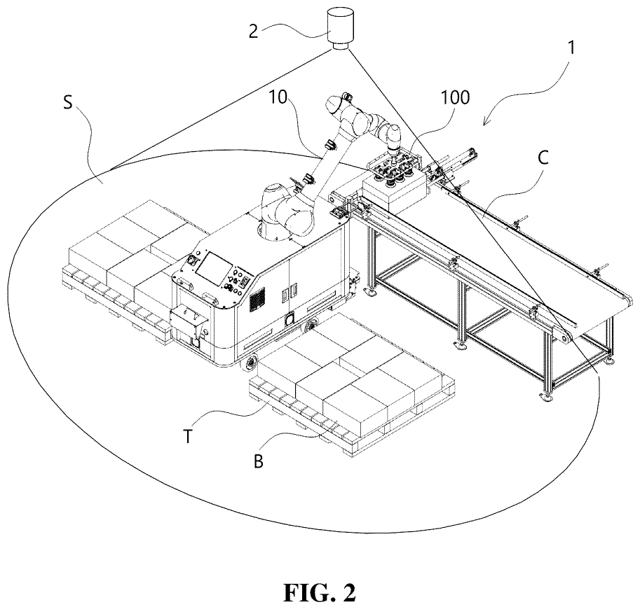

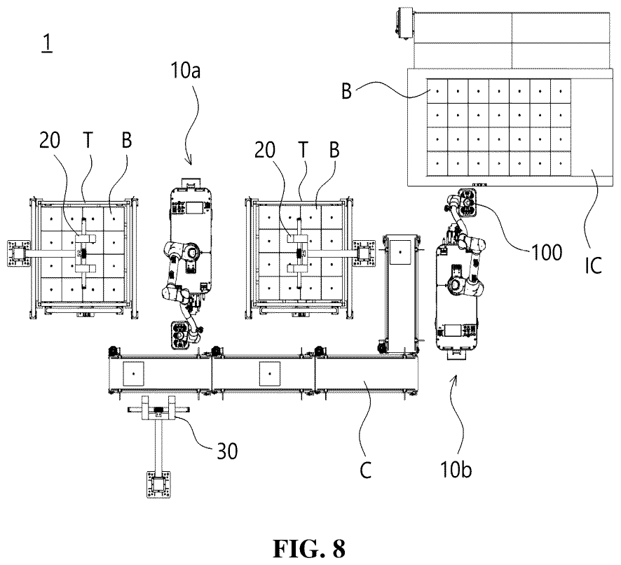

Referring to FIG. 1, in the palletizing safety control area setting method according to the first embodiment of the present disclosure, as shown in FIG. 2, a safety area (S) corresponding to a range for preventing a collision with a transport robot (10) forming a logistics transport and loading system (1) described below in FIG. 8 to transport and load a transport object, or the transport object under transportation and loading is read by a safety area reading device (not shown in the drawing for convenience of description) (S110).

Here, an overall configuration of the logistics transport and loading system (1) will be described later in FIG. 8 and the subsequent drawings.

A safety area reading step (S110) according to one embodiment includes a function of detecting and preventing in advance a probability of collision with a worker or an obstacle located within a movement path of the transport robot (10). In the safety area reading step (S110), the safety area reading device monitors a movement range of the transport robot (10) on a real-time basis, recognizes the presence of the worker or the obstacle located on the movement path, and reflects a recognition result in the safety area (S). In this manner, the transport robot (10) may take essential safety measures for preventing the collision with the worker or the obstacle while the transport robot (10) moves.

The safety area reading device precisely measures the movement range of the transport robot (10) and a distance from the obstacle or the worker, and enables the transport robot (10) to immediately cope with a risk of collision by performing speed control or path changing of the transport robot when the risk of collision is detected. In this manner, safety of the worker may be protected in the safety area (S), a work delay due to the obstacle may be prevented, and a smooth movement of the transport robot (10) may be ensured. Accordingly, safety and efficiency in logistics transport and loading work may be greatly improved.

The safety area reading step (S110) according to one embodiment includes a function of detecting and preventing in advance the probability of collision that may occur when the transport robot (10) picks up and transports the transport object. In the safety area reading step (S110), the safety area reading device reads the safety area (S) on a real-time basis in view of a positional relationship between the transport object transported by the transport robot (10) and the worker or the obstacle located in the movement range of the transport robot (10). In this manner, a safe distance between the transport object under transportation and the worker or the obstacle may be maintained, and all collision possibilities that may occur in a workspace may be prevented.

The safety area reading device continuously monitors positions, speeds, and movement directions of the transport robot (10) and the transport object, and provides information that enables the transport robot (10) to take immediate safety measures, such as speed control or path resetting of the transport robot (10), when the worker or the obstacle approaches the movement path of the robot. This real-time safety reading function may maximize the safety in the workspace, and may ensure a smooth progress of transport work. Accordingly, efficiency in logistics transport and loading work may be improved.

The safety area reading step (S110) according to one embodiment includes a function of setting and reading the safety area (S) in view of transport object characteristics such as a size and a shape of the transport object which the transport robot (10) picks up and transports. In the safety area reading step (S110), the safety area reading device dynamically adjusts the safety area (S) by evaluating how the movement path of the transport robot (10) is affected by the size and the shape of the transport object. In this manner, when the size or the shape of the transport object affects the probability of collision in a work environment, the safety area reading device may realize more precise safety management by setting the safety area (S) adjusted accordingly.

The safety area reading device evaluates a space required for maintaining a safe distance from the worker or the obstacle on a real-time basis, in view of the shape and the size of the transport object, and supports the transport robot to automatically take measures such as speed control and path changing of the transport robot. This function contributes to optimized safety between the transport robot and surrounding elements by reducing the probability of collision in advance, which may occur especially when a large or irregularly shaped transport object is transported.

The safety area (S) read in the safety area reading step is displayed through projection of a projection device (2) (S120).

Here, the projection device (2) shares the movement path of the transport robot (10) and the safety distance from the transport object with the worker on a real-time basis, thereby helping the worker to intuitively recognize the safety area (S). In this manner, the worker may further enhance the safety during work by visually confirming the safety area (S) based on the movement path of the transport robot and the location of the transport object.

The projection device (2) displays the read safety area (S) on a specific area such as a floor or a wall in the workspace so that the worker can identify the movement path and the safety area (S) at a glance and can maintain the safe distance when necessary. This process supports the worker to recognize the approach of the transport robot and to take a proper response, thereby improving the safety of the worker and work efficiency.

The safety area displaying step (S120) according to one embodiment includes a function of visually displaying the safety area (S) by reflecting the transport object characteristics read in the safety area reading step (S110). In the safety area displaying step (S120), the projection device (2) projects the safety area (S) adjusted based on the size and the shape of the transport object under transportation, onto the workspace, thereby enabling the worker to intuitively identify the safety distance set according to the characteristics of the transport object. In this manner, the safety for the transport objects having various sizes and shapes may be more precisely managed, and the worker may be supported to properly cope with situations.

The projection device (2) dynamically adjusts a display of the safety area (S) whenever the size or the shape of the transport object is changed, thereby enabling the worker to always maintain an optimal safety distance around the transport object. In this manner, the safety area (S) is dynamically set in accordance with the transport object characteristics, and the probability of collision between the transport robot (10) and the worker is effectively reduced. Accordingly, the safety and the efficiency in the workspace are improved.

The safety area displaying step (S120) according to one embodiment includes a function of precisely reading characteristics such as the size and the shape of the transport object, through 3D vision recognition using a 3D vision camera. The 3D vision camera may three-dimensionally analyze the transport object in various ways, and may accurately identify physical characteristics of the transport object, such as a height, a width, and a depth. Based on data generated In this manner, the safety area (S) may be set in the safety area reading step (S110).

The transport object characteristics read in this manner are reflected in visually displaying the safety area (S) suitable for the workspace in the safety area displaying step (S120), and enable the worker to intuitively recognize the optimal safety distance based on an actual size and an actual shape of the transport object. This method contributes to optimized safety and efficiency in a work environment for handling the transport objects having various shapes and sizes, and improves both safety awareness of the worker and movement efficiency of the transport robot (10).

In the palletizing safety control area setting method according to the first embodiment of the present disclosure having the above-described configuration, the size and the shape of the transport object are accurately identified through the 3D vision recognition, and the optimal safety area (S) in the workspace is set. In this manner, the safety of the worker is optimized, and an efficient work flow of the transport robot (10) is maintained. Accordingly, there is provided an advantageous effect in which the transport robot (10) flexibly copes with various conditions of the transport object.

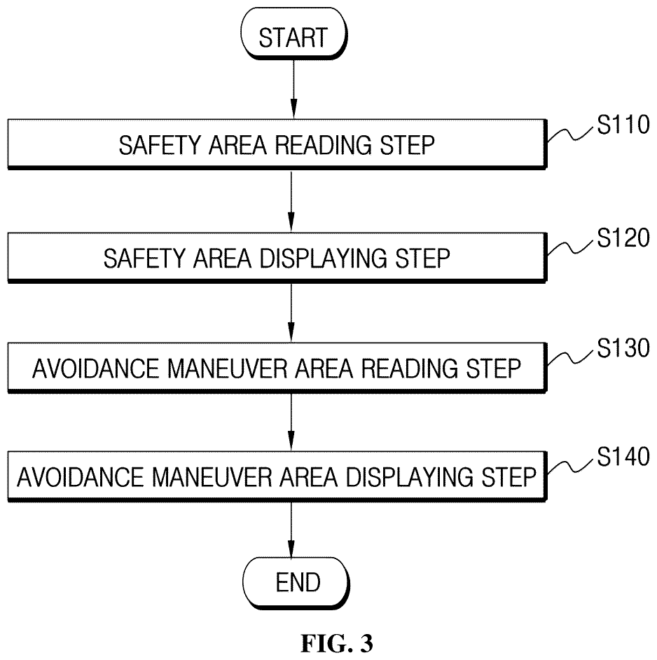

FIG. 3 is a flowchart illustrating a palletizing safety control area setting method according to a second embodiment of the present disclosure.

Referring to FIG. 3, the palletizing safety control area setting method according to the second embodiment of the present disclosure includes, an avoidance maneuver area reading step (S130) in which the transport robot (10) can avoid the collision to prevent the collision when the probability of collision occurring on the path of the transport robot (10) or the transport object is detected while the transport object is transported, after the safety area displaying step (S120).

In the avoidance maneuver area reading step (S130), the safety area reading device analyzes the surrounding environment of the transport robot (10), and set an optimal avoidance path for the transport robot (10) to safely avoid the collision, thereby supporting the transport robot (10) to effectively cope with unexpected collision situations that may occur during work.

The avoidance maneuver area read in the avoidance maneuver area reading step (S130) is visually displayed on the workspace through the projection device (2) (S140). The projection device (2) projects the avoidance maneuver area onto the worker and the surroundings of the transport robot (10) so that the worker can immediately recognize an avoidance path of the transport robot (10) and can intuitively confirm safety measures to prevent the collision. In this manner, the worker may clearly recognize the avoidance maneuver area, and may maintain the safe distance in the avoidance path, thereby further enhancing the safety and the work efficiency of the worker.

The projection device (2) displays a space required for the transport robot (10) to avoid the collision in the workspace, and supports the worker to easily visually identify the avoidance path. This process enables the worker to recognize an expected movement path of the transport robot (10) on a real-time basis and to take necessary measures. In this manner, there is provided an advantageous effect of optimizing the safe movement of the transport robot (10) and the safety of the workspace.

The avoidance maneuver area displaying step (S140) according to one embodiment includes a function of emphasizing and displaying the avoidance maneuver area to visually distinguish the safety area (S) displayed in the safety area displaying step (S120) and the avoidance maneuver area from each other. In the avoidance maneuver area displaying step (S140), the projection device (2) projects the safety area (S) and the avoidance maneuver area by separately projecting both the safety area (S) and the avoidance maneuver area as respectively different visual elements, thereby supporting the worker to intuitively recognize the avoidance maneuver area. For example, the avoidance maneuver area is emphasized and displayed by using colors, patterns, or a brightness difference, thereby enabling the worker to clearly identify the avoidance path of the transport robot (10) and to maintain a proper safety distance.

The projection device (2) dynamically emphasizes the avoidance maneuver area so that the worker more quickly responds to the avoidance path of the transport robot (10), and optimizes visual clarity by preventing confusion with the safety area (S). In this manner, the worker may predict the movement of the transport robot (10) in the workspace on a real-time basis, and minimizes the probability of collision with the transport robot (10), thereby greatly improving the safety of the worker and the efficiency in the workspace.

In the palletizing safety control area setting method according to the second embodiment of the present disclosure having the above-described configuration, the probability of collision with the transport object in the movement path of the transport robot (10) is detected on a real-time basis, and the avoidance maneuver area is displayed by being visually distinguished from the safety area (S). In this manner, the worker may immediately respond to the avoidance maneuver area. Accordingly, there is provided an advantageous effect of improving both the safety of the workspace and the efficiency in the transport work.

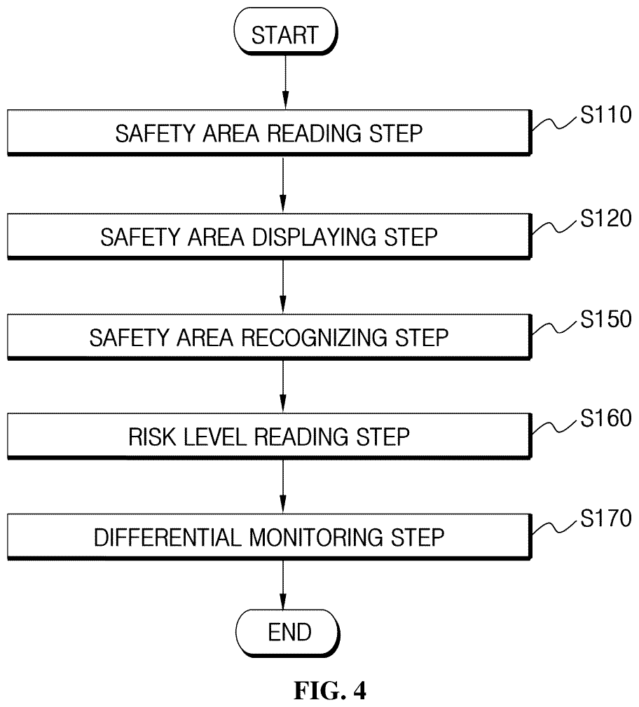

FIG. 4 is a flowchart illustrating a palletizing safety control area setting method according to a third embodiment of the present disclosure.

Referring to FIG. 4, the palletizing safety control area setting method according to the third embodiment of the present disclosure includes a safety area recognizing step (S150) of recognizing the safety area (S) through vision recognition (not shown in the drawing for convenience of description) in the workspace where the safety area (S) is set, after the safety area displaying step (S120).

In the safety area recognizing step (S150), a vision recognition device may monitor the safety area (S) displayed by the projection device (2) on a real-time basis, and may continuously confirm and maintain a current safety status of the workspace. In this manner, approaching of unexpected obstacles or the worker may be automatically detected in the safety area (S), and required safety measures can be immediately taken.

The vision recognition device recognizes the safety area (S) so that the movement path or the avoidance maneuver area of the transport robot (10) can be adjusted depending on a change in the work environment, and enables the worker to quickly identify and cope with risk factors that may occur during a transport process. According to this function, the safety area (S) may be accurately recognized, the safety in the workspace may be enhanced based on the recognition, and a safe interaction may be ensured between the transport robot (10) and the worker.

The palletizing safety control area setting method includes a risk level reading step (S160) of reading a risk level for each of a plurality of the safety areas (S) read in the safety area reading step (S110), based on recognition information recognized in the safety area recognizing step (S150). A risk level reading device (not shown in the drawing for convenience of description) analyzes the recognition information collected through the safety area recognizing step (S150), and evaluates a real-time risk level in view of factors such as a position and a movement speed of the obstacle, the worker, or the transport robot (10) existing in each safety area (S). In this manner, the risk level of each safety area (S) in the work environment may be managed in a hierarchical manner, and the worker may immediately cope with the risk level when the risk level increases in a specific area.

The risk level reading device individually evaluates the plurality of safety areas (S), and supports measures such as path changing of the transport robot (10) or issuing a warning signal to the worker when necessary. As a result, the worker may intuitively identify the risk level of each safety area (S), may more systematically manage the safety in the workspace, and may maintain a smooth work flow of the transport robot (10) by minimizing a potential risk of collision.

The palletizing safety control area setting method includes a differential monitoring step (S170) of differentially monitoring the plurality of safety areas (S), based on the risk level of the safety area (S) which is read in the risk level reading step (S160). In the differential monitoring step (S170), a differential monitoring device (not shown in the drawing for convenience of description) adjusts monitoring intensity depending on the risk level of each safety area (S), and more intensively monitors the safety area (S) in which a relatively high risk level is read. In this manner, the worker may quickly recognize and respond to a potential accident that may occur in an area having a high risk level. Accordingly, both the safety and the efficiency in the workspace may be maintained.

The differential monitoring device sets more frequent monitoring and notifications for the safety area (S) determined to have a high risk level in the risk level reading step (S160), and supports safety measures such as a warning signal or operation control of the transport robot (10) when necessary. Meanwhile, the safety area (S) having a low risk level is maintained with minimal monitoring. In this manner, while system resources are efficiently used, the safety in the overall workspace may be optimized.

In the palletizing safety control area setting method according to the third embodiment of the present disclosure having the above-described configuration, the plurality of the safety areas (S) are individually evaluated through vision recognition and a risk level analysis, and are differentially monitored depending on the risk level. In this manner, there is provided an advantageous effect in which the safety in the workspace is improved and efficiency in using resources is optimized. Accordingly, the risk level of each safety area (S) is monitored on a real-time basis. Therefore, more intensive monitoring and immediate warning notifications may be available in a high risk area, and a work flow may be smoothly maintained with minimal monitoring in a low risk area. In this manner, the worker may quickly recognize the potential risk, and may properly cope with the potential risk. Accordingly, the risk of collision between the transport robot (10) and the worker may be minimized, and a safe and efficient logistics transport work environment may be created.

In addition, the risk level evaluation and the monitoring intensity are dynamically adjusted depending on changes in the safety area (S). Therefore, the present disclosure may provide a useful function that the transport robot (10) can flexibly cope with a changing work environment while maintaining work continuity of the transport robot (10).

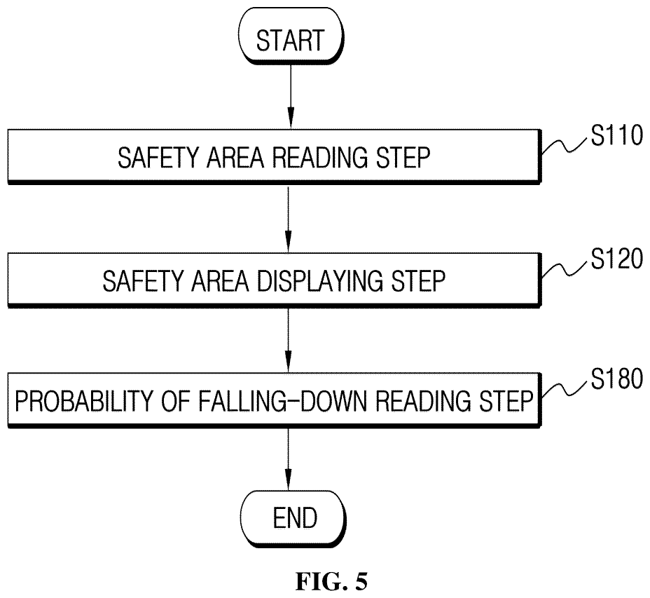

FIG. 5 is a flowchart illustrating a palletizing safety control area setting method according to a fourth embodiment of the present disclosure.

Referring to FIG. 5, the palletizing safety control area setting method according to the fourth embodiment of the present disclosure includes a probability of falling-down reading step (S180) of determining a probability of falling-down of the transport object under transportation, after the safety area displaying step (S120).

In the probability of falling-down reading step (S180), the probability of falling-down reading device (not shown in the drawing for convenience of description) comprehensively analyzes characteristics such as a weight, a size, and a moving speed of the transport object, and evaluates whether the transport object is unstably fixed or has a risk of falling-down during the transport process, on a real-time basis. In this manner, safe transport of the transport object is ensured, and when the risk of falling-down is high, an immediate warning notification is issued or safety measures such as speed control and path changing of the transport robot (10) may be taken.

The probability of falling-down reading device may monitor stability of the transport object on a real-time basis, may ensure the safety of the worker in the workspace, and may prevent potential accidents that may occur along the movement path of the transport robot (10). In this manner, the worker may immediately recognize the risk of falling-down of the transport object, and may maintain a proper safety distance. The system may improve both stability of the transport process and work efficiency.

The probability of falling-down reading step (S180) according to one embodiment includes a function of reading the probability of falling-down by evaluating stability of the transport object fastened to a gripping portion (100) mounted on the transport robot (10). In the probability of falling-down reading step (S180), the probability of falling-down reading device comprehensively considers various factors to determine whether the transport object is safely fastened to the gripping portion (100). These factors include a position of the center of gravity of the transport object, a distribution of a suction pressure generated by a suction cup (320), a suction leak degree, and a surface texture of the transport object.

In particular, whether the suction pressure using a negative pressure is evenly distributed through a plurality of the suction cups (320) installed in an n*n array on a bottom surface of the gripping portion (100) may be read to detect whether a portion of the transport object is unstably fastened or whether there is an area having an insufficient suction force. In addition, when there is the suction cup in which a suction leak occurs, In this manner, stability of a suction state may be evaluated, and the surface texture of the transport object may be analyzed to determine whether the suction cup is suitable for suction. In this manner, a stable fastening state of the transport object may be confirmed.

Through analyzing various factor in this way, the probability of falling-down reading device may take safety measures for maintaining the stability of the transport object. When the risk of falling-down is detected, the probability of falling-down reading device issues a warning signal or adjusts the movement speed and the movement path of the transport robot (10) to minimize the risk of falling-down. In this manner, the worker may confirm whether the transport object is safely fastened, on a real-time basis. Accordingly, the safety in the workspace may be improved, and the work efficiency of the transport robot may be maintained (10).

The safety area reading step (S110) according to one embodiment includes a function of dynamically adjusting the safety area (S) in accordance with the probability of falling-down read in the probability of falling-down reading step (S180). In the safety area reading step (S110), when the probability of falling-down reading device determines that the probability of falling-down of the transport object is high, the safety area (S) is widely set to ensure the safety of the worker and the surrounding environment. In this manner, the potential risk factor that may occur around the movement path of the transport object having a high risk of falling-down may be effectively alleviated.

The safety area reading device flexibly adjusts a size of the safety area (S) in accordance with the falling probability. When the risk of falling-down is low, the safety area (S) is narrowly set to improve work efficiency. On the other hand, when the risk of falling-down is high, the safety area (S) is widened to optimize the safety of the worker and the surrounding environment. In this way, the worker may intuitively recognize the safety distance based on a risk of falling-down level of the transport object, and both the safety in the workspace and the efficiency in the transport work may be improved.

In the palletizing safety control area setting method according to the fourth embodiment of the present disclosure having the above-described steps, the safety area (S) is dynamically adjusted in accordance with the probability of falling-down of the transport object, and the safety of the worker and the surrounding environment is enhanced. The work efficiency is optimized to prevent potential accidents by widely setting the safety area (S) when the risk of falling-down is high, and resources are efficiently used by minimizing the safety area (S) when the risk of falling-down is low. In this manner, both the safety and the efficiency in the workspace may be ensured.

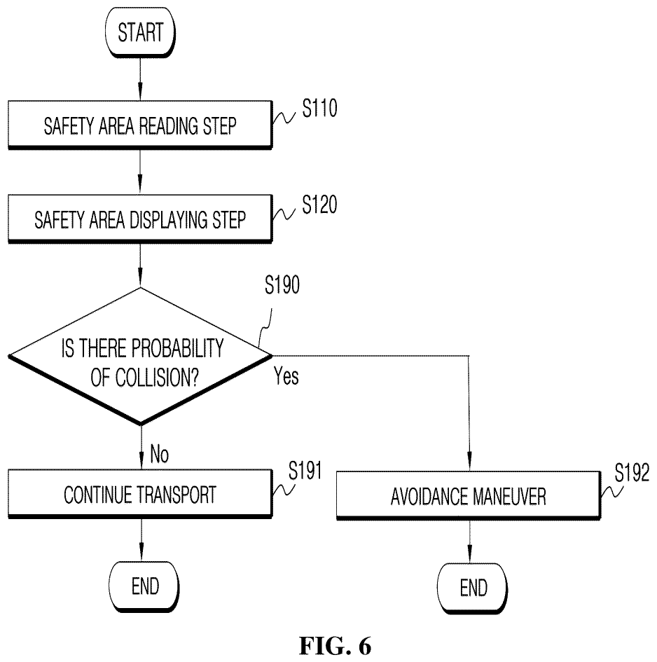

FIG. 6 is a flowchart illustrating a palletizing safety control area setting method according to a fifth embodiment of the present disclosure.

Referring to FIG. 6, in the palletizing safety control area setting method according to the fifth embodiment of the present disclosure, after the safety area displaying step (S120), when it is determined that there is the probability of collision with the transport robot (10) or the transport object under transportation (Yes in S190), the transport robot (10) performs a collision avoidance maneuver (S192). In the avoidance maneuvering step (S192), the transport robot (10) recognizes the surrounding environment, prevents the collision by taking measures such as real-time path adjustment or speed reduction, and ensures the safety of the worker and equipment. In this manner, the risk of accidents caused by the unexpected obstacle or changes in the workspace may be prevented in advance.

On the other hand, when it is determined that there is no probability of collision (a case of No in S190), the transport robot (10) carries out the transport work without any change, and continues the work by using an original path and at a planned speed (S191). In this case, the transport robot (10) may maintain an efficient work flow, and may quickly carry out the transport work without unnecessarily changing the movement path or without controlling the speed. Accordingly, the transport efficiency in the workspace is optimized.

In the palletizing safety control area setting method according to the fifth embodiment of the present disclosure having the above-described steps, the probability of collision of the transport robot (10) and the transport object under transportation is detected on a real-time basis, and an immediate avoidance maneuver is performed when there is the risk of collision. In this manner, the safety in the workspace may be optimized. On the other hand,, when there is no probability of collision, the movement path of the transport robot (10) may be maintained without any change. In this manner, work continuity and efficiency may be optimized.

In this manner, the present embodiment provides an advantageous effect in which the safety of the worker is ensured and operating efficiency of the transport robot (10) is optimized by creating an efficient working environment for minimizing agile responses to the risk of collisions and unnecessary avoidance maneuvers.

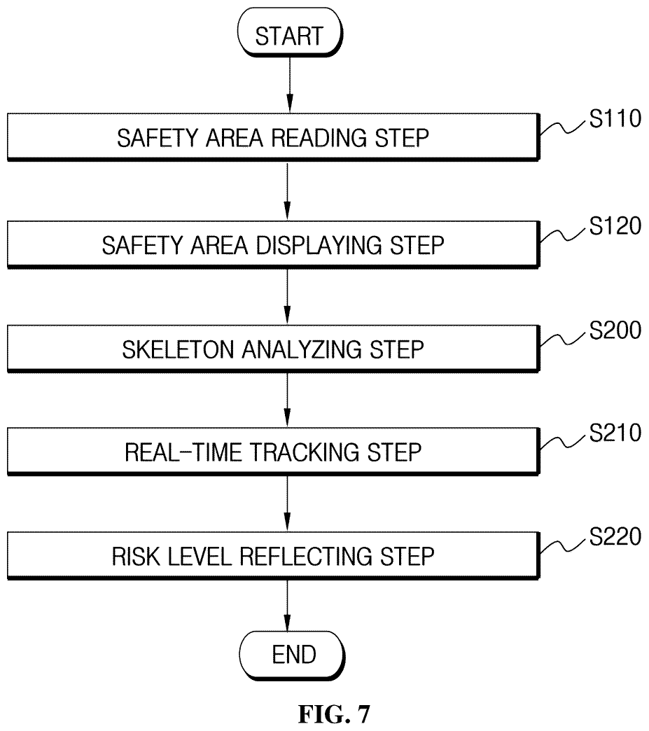

FIG. 7 is a flowchart illustrating a palletizing safety control area setting method according to a sixth embodiment of the present disclosure.

Referring to FIG. 7, the palletizing safety control area setting method according to the sixth embodiment of the present disclosure includes a s skeleton analyzing step (S200) of performing a skeleton analysis on all workers who carry out work through a surveillance camera (not shown in the drawing for convenience of description) in a factory. In the skeleton analyzing step (S200), the surveillance camera tracks a body movements of the workers on a real-time basis, and analyzes a skeleton structure to accurately identify current positions and movements of the workers. In this manner, the risk of collision between the movement paths of the transport robot (10) and the transport object and the movements of the workers may be predicted, and the safety of the workers can be further enhanced.

A skeleton analysis device precisely recognizes a body position and a posture of the worker, and supports safety measures such as providing a warning notification or adjusting the movement path of the transport robot (10) when the worker approaches the movement path of the transport robot (10) or approaches a dangerous zone. This method enables an interaction between the worker and the transport robot (10) to be more safely and efficiently managed, and contributes to the optimized safety in the work environment.

The palletizing safety control area setting method includes a risk level of collision reading step (S210) of reading a risk level of collision by tracking a position and a movement of each of the workers who carry out work, on a real-time basis, based on skeleton information analyzed through the skeleton analyzing step (S200). In the real-time tracking step (S210), a risk level reading device analyzes a position and a body movement of each worker on a real-time basis to evaluate the risk level of collision when the worker approaches the movement path of the transport robot (10) or approaches a danger zone. In this manner, the potential probability of collision depending on the position and the movement of the worker may be predicted in advance.

The risk level reading device monitors the body movement and a position change of the worker on a real-time basis, and maintains the safety by providing a warning notification for the worker whose risk level of collision is high, or by automatically adjusting the movement speed and path of the transport robot (10). In this way, the risk of collision between the worker and the transport robot (10) in the workspace is minimized to provide an environment in which the worker may carries out work while maintaining a safe distance.

The palletizing safety control area setting method includes a risk level reflecting step (S220) of reflecting the risk level of collision read in the real-time tracking step (S210) in setting the transport speed of the transport object or the safety area (S). In the risk level reflecting step (S220), when the risk level of collision reading device detects a situation in which the risk level of collision between the worker and the transport robot (10) in the workspace is raised, the risk level of collision reading device adjusts the speed of the transport object or enlarges the safety area (S) to prioritize the safety of the worker.

When the risk level of collision is high, the transport robot (10) supports the worker to maintain the safety distance by automatically reducing the transport speed or by widely setting the safety area (S) to reduce the probability of collision with the worker. On the other hand, when the risk level of collision is low, the transport robot (10) improves the work efficiency by maintaining the transport speed in the original level or minimizing the safety area (S) when necessary.

In this manner, the worker may be safely protected from the probability of collision that may occur during work, and the transport robot (10) may optimize both the safety and the efficiency by dynamically adjusting the work depending on changes in the work environment.

In the palletizing safety control area setting method according to the sixth embodiment of the present disclosure having the above-described steps, the position and the movement of the worker are tracked on a real-time basis to evaluate the risk level of collision. While the safety of the worker may be prioritized by dynamically adjusting the transport speed and the safety area (S) of the transport object, based on the evaluated risk level of collision, transport work efficiency may be optimized.

In this manner, the probability of collision may be prevented in advance by immediately coping with changes in the position of the worker, the safety area (S) may be widely set to reduce the risk of accidents when the risk level is high, and the speed and the safety area (S) may be optimized to optimize work continuity and resource utilization when the risk level is low.

Therefore, the safety control area setting method according to the present embodiment provides an effective safety control solution which is flexibly applicable in various work environments by maintaining a balance between the safety and the work efficiency.

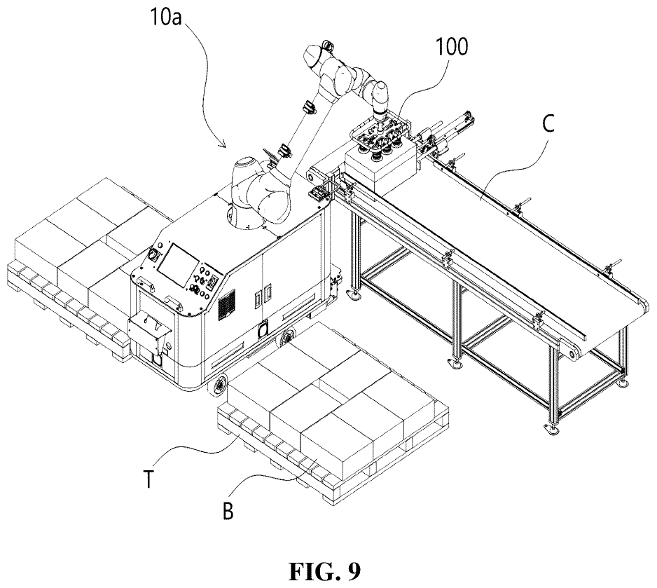

FIGS. 8 and 9 are diagrams showing a schematic configuration of the logistics transport and loading system according to one embodiment of the present disclosure.

Referring to FIGS. 8 and 9, a logistics transport and loading system according to one embodiment of the present disclosure includes at least one transport robot (10), a first identification camera (20), and a second identification camera (30).

In one embodiment, the transport robot (10) may include a plurality of robot arms (not shown), the gripping portion (100), and the suction cups (320) to transport or load a transport object (B) to a specific location. The plurality of robot arms correspond to a collaborative robot or a multi-joint robot.

The transport object (B) serving as a transport target includes waste discharged from a medical site, for example, a box containing items contaminated with a patient's blood or body fluid in gloves, syringes, ampoules, gauze, or paper diapers, which may cause infection. Meanwhile, any item within a payload which can be transported by the transport robot (10) may correspond to the transport object.

The transport robot (10) may move the transport object (B) within a working radius of maximum 1,700 mm with a maximum payload of 25 kg, and may load or unload the transport object (B) up to a loading height of maximum 2.2 m.

When the worker brings a roll container (T) in which the transport object (B) is loaded to a work position, the first identification camera (20) performs 3D vision scanning on the transport object (B) loaded on the roll container (T), and transmits generated scanning data to the transport robot (10).

In one embodiment, the first identification camera (20) may identify the transport object (B) by using a 3D vision scanning method, and basically recognizes the transport object (B) loaded on an uppermost stage. Meanwhile, the first identification camera (20) may cumulatively identify the distribution of the transport object (B) stacked on each layer during the loading process of the transport object (B).

Although not shown in FIG. 8, the present disclosure may include a second identification camera (30) that performs 3D vision scanning on the transport object (B) loaded onto a conveyor (C) from the roll container (T) as in FIG. 9, and that transmits generated scanning data to the transport robot (10).

In the transport robots (10), a first transport robot (10a) transports and loads the transport object (B) loaded on the roll container (T) onto the conveyor (C) in accordance with a preset work order (for example, priority criteria or simple loading order) by using the scanning data received from each of the first identification camera (20) and the second identification camera (30).

In one embodiment, the first transport robot (10a) may detect a position and a shape of the transport object (B) loaded on the roll container (T) by using the scanning data received from the first identification camera (20).

In one embodiment, the first transport robot (10a) may sequentially transport and load the transport object (B) loaded on the roll container (T) onto the conveyor (C) in accordance with a preset work order (for example, the order of the transport object (B) loaded on a lower side from the transport object (B) loaded on an upper stage, or the order of the transport object (B) loaded on a right side from the transport object (B) loaded on a left side).

In one embodiment, the first transport robot (10a) may transport and load the transport object (B) loaded on the uppermost stage of the roll container (T) onto the conveyor (C) in the work order set based on a priority.

In one embodiment, the first transport robot (10a) may transport and load each layer of the transport objects (B) loaded in multiple layers on the roll container (T) onto the conveyor (C) in the work order set based on the priority (for example, the order of oldest discarded date).

In one embodiment, when the transport object (B) with a higher priority exists on a lower layer than the transport object (B) with a lower priority, the first transport robot (10a) may determine the work order again as follows. The first transport robot (10a) temporarily transports all or some of the transport objects (B) with the lower priority, which are located on the upper side of the layer where the transport object s(B) with the higher priority exist, to the conveyor (C), and thereafter, temporarily transports the transport object (B) to the roll container (T). The first transport robot (10a) rearranges the transport objects (B) loaded on the roll container (T) so that the transport object (B) with the higher priority is disposed on the upper layer.

In summary, when a precedent loading transport object which is the transport object to be loaded first in accordance with the set work order exists on the lower layer of a subsequent loading transport object which is the transport object to be loaded subsequently, the first transport robot (10a) may determine the work order again as follows. The first transport robot (10a) temporarily transports all or some of the subsequent loading transport objects located on the upper side of the layer where the precedent loading transport objects exist, to the conveyor (C), and thereafter, temporarily transports the subsequent loading transport objects to the roll container (T), and thereafter, rearranges the transport objects (B) loaded on the roll container (T) so that the precedent loading transport objects are disposed on the upper layer. Meanwhile, when the transport objects (B) loaded on two or more roll containers (T) need to be arranged, the work order may be determined by temporarily transporting the transport object (B) between the roll containers (T) instead of the conveyor (C).

In one embodiment, when the transport object (B) need to be transported first to the conveyor (C) in accordance with the priority is found in the roll container (T), the first transport robot (10a) temporarily aligns the transport objects loaded first on the conveyor (C) in the conveyor (C), and thereafter, transports the transport object found in the roll container (T) to the conveyor (C). In this manner, the first transport robot (10a) may re-arrange the transport objects temporarily aligned on the conveyor (C).

The second transport robot (10b) loads and transports the transport object (B) moved by operating the conveyor (C) to another position.

The logistics transport and loading system according to one embodiment of the present disclosure may further include an incinerator conveyor (IC) for incinerating the transport object (B), and when the incinerator conveyor (IC) is included, the second transport robot (10b) loads and transports the transport object (B) moved to the conveyor (C) to the incinerator conveyor (IC).

With regard to the transport robot (10), the robot arm is the multi-joint robot having at least one joint, and moves the gripping portion (100) in various directions and at various angles.

The gripping portion (100) may include a suction portion (300) provided to suction the transport object (B) by using a vacuum. The suction portion (300) may be operated by a control module (not shown), and may suction various types of the transport objects (B) having a box shape by using the vacuum.

In other words, the gripping portion (100) may be installed in the other end of the transport robot (10), and may be fastened to the transport object (B) or may be separated from the fastened transport object (B).

Although not shown in FIGS. 8 and 9, the transport robot (10) may include sensors. Each of the sensors senses each object located within a certain distance from the transport robot (10), and transmits sensed sensing information to a control module that controls the operation of the transport robot (10). In one embodiment, the sensor is installed to prevent accidents caused by equipment in the vicinity while the transport robot (10) is operated. When the worker is closer to the sensor, the sensor may transmit a signal to the control module to temporarily stop the transport robot (10), and when the worker moves away again, the sensor may cut off the signal to restart the transport robot (10).

Hereinafter, the gripping portion (100) of the transport robot (10) will be described in detail.

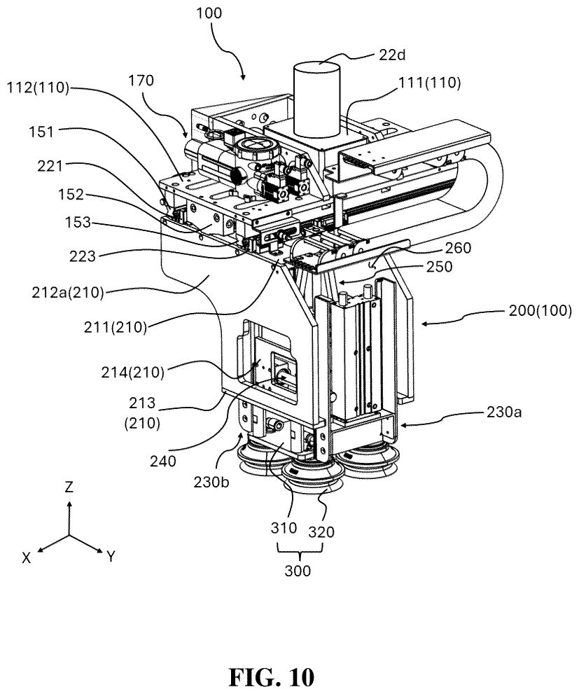

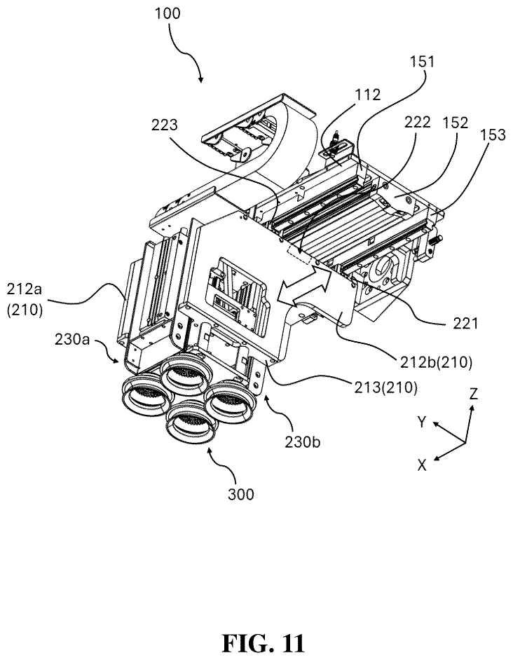

FIG. 10 is a perspective view showing the gripping portion connected to the robot arm according to one embodiment. FIG. 11 is a diagram shown at an angle different from an angle in FIG. 10.

Referring to FIG. 10, the gripping portion (100) may include a fixing body (110) and a gripper assembly (200) connected to the fixing body (110).

The fixing body (110) may be coupled to the transport robot (10). In this manner, the gripping portion (100) may be e movable in response to the movement of the transport robot (10).

The fixing body (110) may include a first fixing body (111) directly coupled to the transport robot (10), and a second fixing body (112) coupled to the first fixing body (111) and connectable to the gripper assembly (200, described below) configured to grip the transport object (B).

As an example, the first fixing body (111) may have a substantially rectangular parallelepiped shape, and may be effectively coupled to the transport robot (10). Meanwhile, the shape of the first fixing body (111) is not limited to the above-described shape, and as a matter of course, the first fixing body (111) may be provided in various ways depending on requirements of each industrial site.

The second fixing body (112) may be disposed on a lower side (-Z side) of the first fixing body (111). For example, the first fixing body (111) may be mounted on an upper surface (surface facing +Z) of the second fixing body (112).

As an example, the second fixing body (112) may include a plate shape extending in a horizontal direction (+−X direction, +−Y direction), but the configuration is not limited thereto.

The gripping portion (100) may include rail portions (151, 152, and 153) mounted on the fixing body (110) and connected to the gripper assembly (200) to move the gripper assembly (200). For example, the rail portions (151, 152, and 153) may include a first rail portion (151), a second rail portion (152), and a third rail portion (153) which are mounted on the lower surface (surface facing-Z) of the second fixing body (112).

The first rail portion (151), the second rail portion (152), and the third rail portion (153) may be arranged to be separated from each other. The first rail portion (151), the second rail portion (152), and the third rail portion (153) may be installed on the lower surface of the second fixing body (112) to extend in a forward-backward direction (+−X direction). As will be described later, the gripper assembly (200) may be connected to each of the first rail portion (151), the second rail portion (152), and the third rail portion (153) to move in the forward-backward direction. As an example, the second rail portion (152) may be formed to be thicker than the first rail portion (151) and the third rail portion (153), but the configuration is not limited thereto.

The gripper assembly (200) may include a gripper body (210), slide portions (221, 222, and 223) coupled to the gripper body (210) and connected to the rail portion, a gripping module (230) provided to grip the transport object (B), a first hydraulic module (250) provided to move the gripping module (230), and a movement guide (240) that guides the movement of the gripping module (230).

The gripper body (210) may include an upper base (211) having an upper surface on which a first slide portion (221), a second slide portion (222), and a third slide portion (223) of the slide portions (221, 222, and 223) are respectively installed. The upper base (211) may be disposed to face the second fixing body (112). As an example, the shape of the upper base (211) may include a plate shape extending in the horizontal direction, but the configuration is not limited thereto.

The first slide portion (221) may be installed at a position corresponding to the first rail portion (151) on the upper surface of the upper base (211). The first slide portion (221) may be slidably coupled to the first rail portion (151). The first slide portion (221) may be coupled to the first rail portion (151) to slide in the forward-rearward direction.

The second slide portion (222) may be installed at a position corresponding to the second rail portion (152) on the upper surface of the upper base (211). The second slide portion (222) may be slidably coupled to the second rail portion (152). The second slide portion (222) may be coupled to the second rail portion (152) to slide in the forward-rearward direction.

The third slide portion (223) may be installed at a position corresponding to the third rail portion (153) on the upper surface of the upper base (211). The third slide portion (223) may be slidably coupled to the third rail portion (153). The third slide portion (223) may be coupled to the third rail portion (153) to slide in the forward-rearward direction. In this manner, the upper base (211) may slide in the forward-rearward direction.

The gripper body (210) may include a first side wall (212a) and a second side wall (212b) which are respectively installed in both ends of the upper base (211) in the forward-rearward direction and extend downward. The first side wall (212a) and the second side wall (212b) may each include openings, and may be disposed to be separated from each other in the forward-rearward direction.

The first hydraulic module (250), the gripping module (230), and the movement guide (240) may be located in a space formed by separation between the first side wall (212a) and the second side wall (212b). In this manner, the first hydraulic module (250), the gripping module (230), and the movement guide (240) may be protected from the outside by the first side wall (212a) and the second side wall (212b).

The gripper body (210) may include a lower base (213) coupled to each end of the lower side of the first side wall (212a) and the second side wall (212b) and extending in the horizontal direction. The lower base (213) may extend in a direction parallel to the upper base (211).

As an example, the upper base (211), the first side wall (212a), the second side wall (212b), and the lower base (213) may form an accommodation groove (260). In other words, the accommodation groove (260) may be a space surrounded by the upper base (211), the first side wall (212a), the second side wall (212b), and the lower base (213).

The first hydraulic module (250), the gripping module (230), and the movement guide (240) may be accommodated in the accommodation groove (260). More specifically, the gripping module (230) may grip the transport object (B). When the gripping module (230) does not grip the transport object (B), the gripping module (230) may be accommodated in the accommodation groove (260). Details thereof will be described later.

The suction portion (300) may fasten the transport object (B) by using the vacuum. As an example, the suction portion (300) may be installed on the lower surface of the lower base (213), and may extend downward.

More specifically, the suction portion (300) may include a suction body (310) coupled to the lower base (213) of the gripper body (210), and the suction cup (320) installed in the suction body (310) and provided to come into contact with the transport object (B).

As an example, the suction body (310) may have a plate shape extending in a direction corresponding to an extending direction of the lower base (213), but the configuration is not limited thereto.

The suction cup (320) may be installed on the lower surface of the suction body (310), and may suction the transport object (B) by using vacuum. The gripping portion (100) may include a vacuum module (170) installed in the fixing body (110).

As an example, the vacuum module (170) may include a configuration operable so that air is drawn and discharged to form a vacuum state.

The vacuum module (170) may be connected to the suction cup (320). Accordingly, when the vacuum module (170) is operated, the air inside the suction cup (320) may flow to the vacuum module (170) to form the vacuum state inside the suction cup (320). Thereafter, the gripping portion (100) may be moved to the upper side of the transport object (B) by the transport robot (10), and the suction portion (300) may come into contact with the upper surface of the transport object (B) to suction the transport object (B). In this manner, the transport object (B) may be stably fixed to the gripping portion (100) by an operation of the suction portion (300).

The gripper body (210) may include a pair of connecting bases (214) installed on the upper surface of the lower base (213) and extending upward. The connecting bases (214) may be separated from each other.

The pair of connecting bases (214) may be respectively installed on one end side of the lower base (213) in the forward-rearward direction. A space formed by separation between the pair of connecting bases (214) may be a smaller space than the space of the accommodation groove (260). An extending length of each of the pair of connecting bases may be shorter than an extending length of the first side wall (212a) or the second side wall (212b) in an upward-downward direction, but the configuration is not limited thereto.

The gripping module (230) may grip the transport object (B). The first hydraulic module (250) may be operable to move the gripping module (230) in a direction parallel to a first direction. As an example, the first direction may mean a rightward-leftward direction (+−Y direction), but the configuration is not limited thereto. The gripping module (230) may be connected to the first hydraulic module (250).

The gripping module (230) may include a first gripping module (230a) disposed on one side of the fixing body (110) and a second gripping module (230b) installed on a side opposite to the first gripping module (230a) with reference to the first hydraulic pump (251). That is, the gripping module (230) may include a pair of the gripping modules (230a and 230b). The pair of the gripping modules (230a and 230b) may be separated from each other. The pair of the gripping modules (230a and 230b) may dispose the transport object (B) in a space separated from each other, and may move toward each other to grip the transport object (B). Details thereof will be described later.

The first hydraulic module (250) may be operated to pressurize the pair of gripping modules (230a and 230b) accommodated in the accommodation groove (260) in an outward direction of the accommodation groove (260). The first hydraulic module (250) may be connected to each of the pair of gripping modules (230a and 230b).

The first hydraulic module (250) may be installed on the lower base (213). The first hydraulic module (250) may be disposed between the pair of connecting bases (214).

The first hydraulic module (250) may be operated to pressurize the pair of gripping modules (230a and 230b) located outside the accommodation groove (260) in a direction facing the accommodation groove (260). The first hydraulic module (250) will be described later.

The movement guide (240) may guide the movement of the gripping module (230) that moves in response to an operation of the first hydraulic module (250). The movement guide (240) may be connected to the gripping module (230). The movement guide (240) may be accommodated in the accommodation groove (260).

The movement guide (240) may be installed on an inner surface of the connecting base (214). As an example, the inner surface of the connecting base (214) may mean a surface of the connecting base (214) which faces the first hydraulic module (250). The movement guide (240) will be described in detail later.

Referring to the above-described configuration, the upper base (211) may be slidably connected to the second fixing body (112). In addition, the first side wall (212a) and the second side wall (212b) are coupled to the upper base (211), and the lower base (213) is coupled to the first side wall (212a) and the second side wall (212b). In addition, the first hydraulic module (250) and the connecting base (214) may be coupled to the lower base (213), and the movement guide (240) may be coupled to the connecting base (214). In addition, the gripping module (230) may be connected to the first hydraulic module (250) and the movement guide (240).

In conclusion, the gripper assembly (200) may be slidably connected to the second fixing body (112), and may slide along the forward-rearward direction in which the second fixing body (112) extends. As an example, the control module may control the movement of the gripper assembly by controlling the first slide portion (221), the second slide portion (222), and the third slide portion (223). In this manner, the gripper assembly (200) may be moved to a position where the gripper assembly (200) effectively grip the transport object (B).

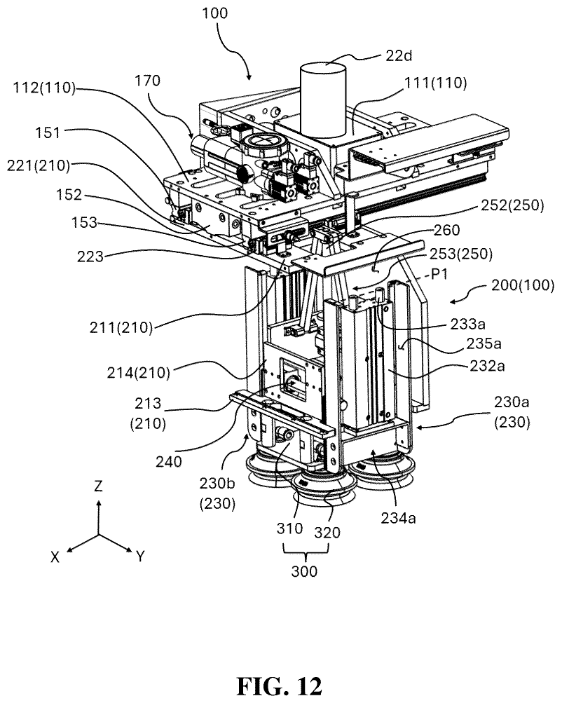

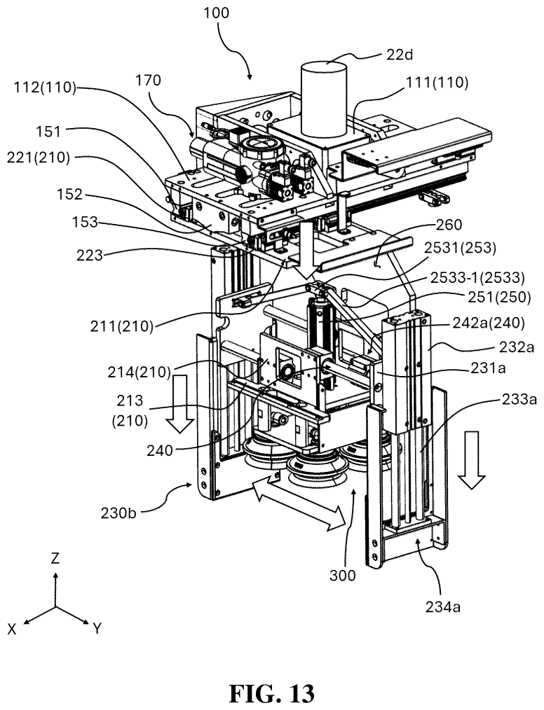

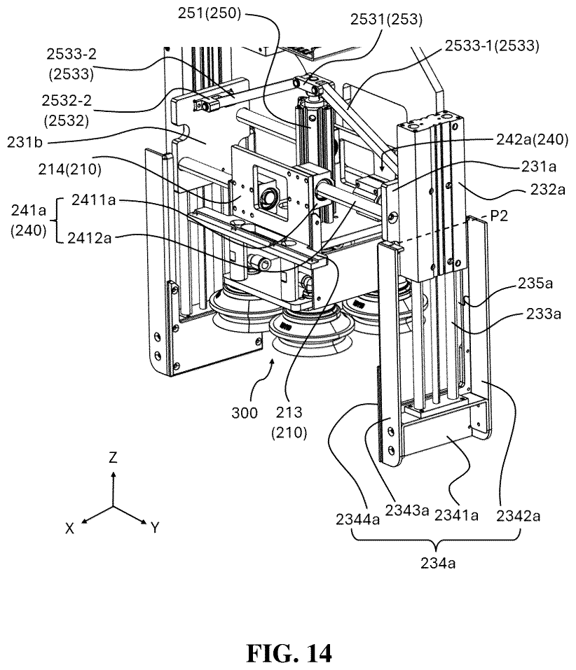

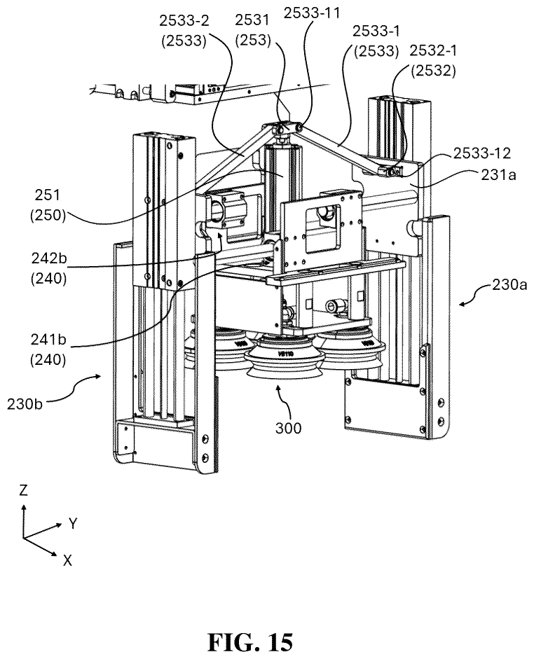

FIG. 12 is a diagram in which some of components of a detachment assembly in FIG. 10 are omitted to show internal components of the detachment assembly in more detail. FIG. 13 is a diagram showing a state where the gripping module moves in response to an operation of the first hydraulic module in the detachment assembly in FIG. 12. FIG. 14 is a partially enlarged view of a portion in FIG. 13. FIG. 15 is a diagram shown at an angle different from an angle in FIG. 14. Hereinafter, repeated description of the above-described contents will be omitted.

Referring to FIGS. 12 to 14, the first hydraulic module (250) may be connected to the pair of the gripping modules (230a and 230b). Before the first hydraulic module (250) moves the pair of the gripping modules (230a and 230b), the pair of the gripping modules (230a and 230b) may be accommodated in the accommodation groove (260). That is, the gripping modules (230) may be accommodated in the accommodation groove (260) when not in use. Accordingly, interference with other loaded transport objects (B) may be minimized when the gripping portion (100) moves.

The first hydraulic module (250) may be connected to each of the pair of the gripping modules (230a and 230b), and may move the pair of the gripping modules (230a and 230b) outward from the accommodation groove (260). As an example, the first hydraulic module (250) may be operated to move the pair of the gripping modules (230a and 230b) in a direction parallel to the first direction. As an example, the direction parallel to the first direction may mean the forward-rearward direction (+-Y direction), but the configuration is not limited thereto.

Hereinafter, for the convenience of description, the description of the first hydraulic module (250) will be continued based on the first gripping module (230a) which is one of the pair of gripping modules (230a and 230b). As a matter of course, the description based on the first gripping module (230a) may be applicable to the second gripping module (230b) within the applicable scope. In addition, for the convenience of description, the first gripping module (230a) will be referred to and described as ‘the gripping module’. In addition, when the first gripping module (230a) and the second gripping module (230b) need to be distinguished from each other, the first gripping module (230a) and the second gripping module (230b) will be separately described.

The first hydraulic module (250) may include a first hydraulic pump (251) installed on the lower base (213), a first hydraulic shaft (252) connected to the first hydraulic pump (251) and configured to move in a direction parallel to a second direction intersecting the first direction, and a crank (253) connecting the first hydraulic shaft (252) and the gripping module (230a) to transmit the movement to the gripping module (230a) by converting the movement of the first hydraulic shaft (252) in the direction parallel to the second direction into the movement in the direction parallel to the first direction.

The first hydraulic pump (251) may include a cylinder shape extending in the upward-downward direction. The first hydraulic shaft (252) may be inserted into the first hydraulic pump (251) to move in a direction parallel to the second direction. As an example, the direction parallel to the second direction may mean the upward-downward direction, but the configuration is not limited thereto.

As an example, one end of the first hydraulic shaft (252) may be located outside the first hydraulic pump (251), and the other end of the first hydraulic shaft (252) may be inserted into the first hydraulic pump (251).

The first hydraulic pump (251) may be disposed between the pair of connecting bases (214). The first hydraulic shaft (252) may be disposed between the pair of connecting bases (214).

The gripping module (230a) may include a connecting member (231a) connected to a crank (253) and disposed to face the accommodation groove (260). The connecting member (231a) may have a substantially plate shape, but the configuration is not limited thereto.

The crank (253) may include a first hinge (2531) coupled to one end of the first hydraulic shaft (252) located outside of the first hydraulic pump (251), a second hinge (2532) coupled to the connecting member (231a) of each of the first gripping module (230a) and the second gripping module (230b), and a crank body (2533) connecting the first hinge (2531) and the second hinge (2532).

As an example, the crank body (2533) may have a rod shape extending in one direction, but the configuration is not limited thereto.

The first hinge (2531) may move along the movement of the first hydraulic shaft (252) in the direction parallel to the second direction. That is, the first hinge (2531) may move in the direction parallel to the second direction.

One end of the crank body (2533) may be connected to the first hinge (2531). In other words, one end of the crank body (2533) may move in the direction parallel to the second direction.

As will be described later, the movement direction of the connecting member (231a) of the gripping module (230a) may be limited to the direction parallel to the first direction by the movement guide (240). Accordingly, a second hinge (2532-1) coupled to the connecting member (231a) may move in the direction parallel to the second direction. In conclusion, the other end of the crank body (2533-1) connected to the second hinge (2532-1) may move in the direction parallel to the second direction.

The crank body (2533) may rotate with reference to on one end of the crank body (2533-1) connected to the first hinge (2531) and the other end of the crank body (2533-1) connected to the second hinge (2532). In other words, the crank body (2533-1) may rotate with reference to on one end of the crank body (2533-1), and may rotate with reference to the other end of the crank body (2533-1).

In this manner, the crank body (2533-1) may perform both a rotational motion and a translational motion, and the motions may be transmitted to the connecting member (231a) while converting a motion of the first hydraulic shaft (252) moving in the direction parallel to the second direction into a motion in the direction parallel to the first direction.

The second gripping module (230b) which is the other one of the pair of gripping modules (230a and 230b) may be disposed on a side opposite to the first gripping module (230a) with reference to the first hydraulic module (250).

As an example, the second hinge (2532) may include a 2-1 hinge (2532-1) coupled to the first gripping module (230a) and a 2-2 hinge (2532-2) coupled to the second gripping module (230b). In addition, the crank body (2533) may include a first crank body (2533-1) connecting the first hinge (2531) and the second-first hinge (2532-1), and a second crank body (2533-2) connecting the first hinge (2531) and the second-second hinge (2532-2).

When the first hydraulic shaft (252) moves in the direction parallel to the second direction, the first crank body (2533-1) may rotate with reference to one end (2533-11) of the first crank body connected to the first hinge (2531) and the other end (2533-12) of the first crank body connected to the 2-1 hinge (2532-1). In this manner, the first crank body (2533-1) may convert the movement of the first hydraulic shaft (252) in the direction parallel to the second direction into the movement of the first gripping module (230a) in the direction parallel to the first direction.

When the first hydraulic shaft (252) moves in the direction parallel to the second direction, the second crank body (2533-2) may rotate with reference to one end of the second crank body (2533-2) connected to the first hinge (2531) and the other end of the second crank body (2533-2) connected to the 2-2 hinge (2532-2). In this manner, the second crank body (2533-2) may convert the movement of the first hydraulic shaft (252) in the direction parallel to the second direction into the movement of the second gripping module (230b) in the direction parallel to the first direction.

As an example, the 2-1 hinge (2532-1) may be coupled to the connecting member (231a) of the first gripping module (230a). As an example, the 2-2 hinge (2532-2) may be coupled to the connecting member (231a) of the second gripping module (230b).

As an example, the movement directions of the first gripping module (230a) and the second gripping module (230b) may be opposite to each other. As an example, when the first gripping module (230a) is moved in the first direction by the first hydraulic module (250), the second gripping module (230b) may be moved in the direction opposite to the first direction by the operation of the first hydraulic module (250).

As an example, the movement guide (240) may include a plurality of movement guides (241a, 242a, 241b, and 242b).

As an example, the first gripping module (230a) may be connected to two movement guides (241a and 242a), and the second gripping module (230b) may be connected to two movement guides (241b and 242b), but the configuration is not limited thereto.

The two movement guides (241a and 242a) connected to the first gripping module (230a) may be disposed to be separated from each other in the second direction, and may be disposed to be separated from each other in a third direction which is a direction intersecting each of the first direction and the second direction.

Hereinafter, the movement guide (240) will be described with reference to one movement guide (241a) of the two movement guides (241a and 242a) connected to the first gripping module (230a). As a matter of course, the description of the movement guide (240) described below may be equally applicable to each of the movement guides (241a, 242a, 241b, and 242b) connected to the first gripping module (230a) and the second gripping module (230b). Hereinafter, the first gripping module (230a) will be referred to as the ‘gripping module (230a)’.

The movement guide (241a) may include a guide bar (2412a) connected to one surface of the connecting member (231a) of the gripping module (230), and a guide socket (2411a) fixed to the connecting base (214) and disposed so that the guide bar (2412a) can pass therethrough.

The guide bar (2412a) may be disposed to extend in the direction parallel to the first direction. As an example, the guide bar (2412a) may have a rod shape extending in the direction parallel to the first direction, but the configuration is not limited thereto.

As an example, the guide socket (2411a) may be fixed to an inner surface of the connecting base (214). The guide socket (2411a) may have a hollow cylindrical shape including a through hole, and the guide bar (2412a) may be inserted into the through hole. The guide bar (2412a) may be movable by penetrating the guide socket (2411a).

As an example, the through hole of the guide socket (2411a) may extend in the direction parallel to the first direction. Accordingly, the guide bar (2412a) may be inserted into the through hole to slide in the direction parallel to the first direction.

One end of the guide bar (2412a) may be connected to the connecting member (231a) of the gripping module (230a). As an example, one end of the guide bar (2412a) may be connected to one surface of the connecting member (231a) facing the accommodation groove (260). As an example, one end of the guide bar (2412a) may be connected to one surface of the connecting member (231a) in which the second hinge (2532) is installed, but the configuration is not limited thereto. As an example, the guide bar (2412a) may be vertically connected to the connecting member (231a).

The through hole of the guide socket (2411a) may extend in the direction parallel to the first direction, and the guide bar (2412a) may slide in the direction parallel to the first direction. Therefore, the connecting member (231a) connected to the guide bar (2412a) may move in the direction parallel to the first direction. Accordingly, the connecting member (231a) may be moved in the direction parallel to the first direction by the operation of the first hydraulic module (250). In this manner, the gripping module (230a) may move in the direction parallel to the first direction.

As an example, the guide socket (2411a) may be installed in the connecting base (214a) to be disposed at a position closer to the gripping module (230a) than the first hydraulic module (250a).

As described above, the first gripping module (230a) may be connected to each of the movement guides (241a and 242a) which are separated from each other in the second direction and the third direction. In addition, the second gripping module (230b) may be connected to each of the movement guides (241b and 242b) which are separated from each other in the second direction and the third direction.

As an example, in the mutually different movement guides (241a and 241b) connected to one of the pair of the connecting bases (214), the movement guide (240) connected to the first gripping module (230a) and the movement guides (241a and 241b) connected to the second gripping module (230b) may be disposed to be separated from each other in the direction parallel to the first direction and the second direction.

Hereinafter, for the convenience of description, the gripping module (230) will be described with reference to the first gripping module (230a). Hereinafter, for the convenience of description, the first gripping module (230a) will be referred to as the gripping module (230a) within the necessary scope. In addition, as a matter of course, the following description regarding the first gripping module (230a) may be equally applicable to the second gripping module (230b) within the corresponding scope.

The gripping module (230a) may include a connecting member (231a) including one surface coupled to the crank (253), a second hydraulic pump (232a) installed on the other surface of the connecting member (231a), a second hydraulic shaft (233a) connected to the second hydraulic pump (232a) and movable in the direction parallel to the second direction, and a gripping member (234a) connected to a lower side of the second hydraulic shaft (233a), movable in the direction parallel to the second direction, and capable of gripping the transport object (B) by coming into contact with the transport object (B).

As described above, the connecting member (231a) may have a plate shape vertically coupled to the guide bar (2412a) of the movement guide (241a).

The second hydraulic pump (232a) may be formed to extend in the direction parallel to the second direction. The second hydraulic pump (232a) may be installed on one surface of the connecting member (231a) facing a side opposite to the accommodation groove (260).

The second hydraulic shaft (233a) may be mounted on the second hydraulic pump (232a). The second hydraulic shaft (233a) may be moved in the direction parallel to the second direction by the operation of the second hydraulic pump (232a).

The gripping member (234a) may include a first member body (2341a) coupled to a lower end of the second hydraulic shaft (233a) and extending in the direction parallel to the third direction, a pair of second member bodies (2342a and 2343a) respectively extending in the direction parallel to the second direction from both ends of the first member body (2341a) in the direction parallel to the third direction, and a third member body (2344a) coupled to one surface of each of the pair of second member bodies (2342a and 2343a) facing the first hydraulic pump (251). As an example, the third direction may mean the forward-rearward direction (+−X direction), but the configuration is not limited thereto.

The first absence body (2341a) may be formed to extend in the direction parallel to the third direction.

The pair of second member bodies (2342a, 2343a) may be disposed to be separated from each other in the third direction. The pair of second member bodies (2342a, 2343a) may be installed in each of both ends of the first member body (2341a). A space formed by separation between the pair of second member bodies (2342a, 2343a) may be referred to as a separation space (235a). As an example, the first member body (2341a) may form a lower end portion of the separation space (235a).

The second hydraulic pump (232a) and the second hydraulic shaft (233a) may be accommodated in the separation space (235a). In this manner, the second hydraulic pump (232a) and the second hydraulic shaft (233a) may be protected from external interference by the pair of second member bodies (2342a and 2343a).

The third member body (2344a) may be installed to be in contact with each surface of the pair of second member bodies (2342a and 2343a) facing the first hydraulic pump (251). In other words, the third member body (2344a) may be installed on each surface of the pair of second member bodies (2342a and 2343a) facing the accommodation groove (260). In addition, the third member body (2344a) may be coupled to the first member body (2341a) to be in contact with one surface of the first member body (2341a) facing the accommodation groove (260). Since the plurality of configurations and the third member body (2344a) are respectively coupled, installation rigidity of the third member body (2344a) can be increased.

As an example, one surface of the third member body (2344a) disposed to face the accommodation groove (260) may come into contact with the transport object (B). As an example, one surface of the third member body (2344a) facing the accommodation groove (260) may have various materials and shapes to increase a frictional force with the transport object (B).

As described above, the first member body (2341a) is connected to the second hydraulic shaft (233a) which is movable in the direction parallel to the second direction. Therefore, the third member body (2344a) connected to the first member body (2341a) is movable in the direction parallel to the second direction.

As an example, the third member body (2344a) may be movable to be located below the suction portion (300). As an example, the third member body (2344a) may be movable to be located above the suction portion (300).

More specifically, the gripping member (234a) may be movable between a first position (P1, refer to FIG. 12) located to accommodate the second hydraulic pump (232a) in a space formed by separation between the pair of second member bodies (2342a, 2343a), and a second position (P2, refer to FIG. 14) located to accommodate a portion of the second hydraulic pump (232a) in the separation space (235a).

As an example, when the gripping member (234a) is located at the first position (P1), the third member body (2344a) may be located above the suction portion (300). That is, when the gripping module (230) does not grip the transport object (B), the gripping member (234a) may be located at the first position (P1). As an example, when the gripping member (234a) is located at the second position (P2), the third gripping member (234a) may be located below the suction portion (300). Since the suction cup (320) of the suction portion (300) is provided to come into contact with the upper surface of the transport object (B), the third gripping member (234a) may move further downward to come into contact with the side surface of the transport object (B).

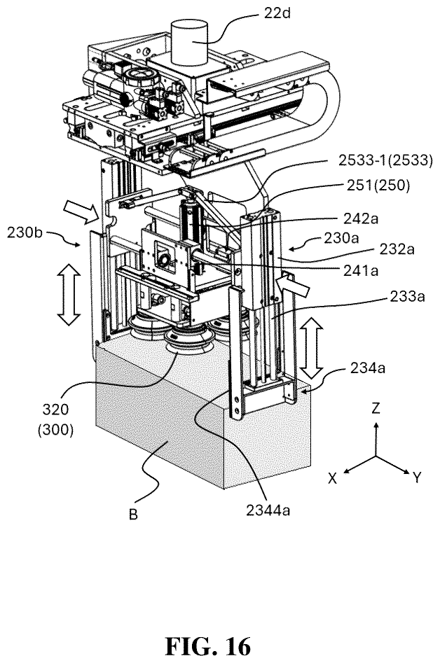

FIG. 16 is a diagram showing a state where a transport device according to one embodiment of the present invention grips and suctions an object. Hereinafter, a process in which the detachment assembly transports an object will be described in detail. Repeated description of the contents will be omitted below.

Referring to FIG. 16, the control module may control transport units (21 and 22) so that the transport units (21 and 22) transport the gripping portion (100) to a position adjacent to the transport object (B). As an example, in a state where the gripping module (230) is in a standby state where the gripping module (230) does not grip the transport object (B), the gripping member (234a) may be located at the first position (P1), and the gripping module (230) may be in an accommodated state in the accommodation groove (260).

After the gripping portion (100) is moved to a position adjacent to the transport object (B), the control module may control the first hydraulic pump (251) to lower the first hydraulic shaft (252). In this manner, the crank (253) may pressurize the first gripping module (230a) and the second gripping module (230b) to move outward from the accommodation groove (260). That is, in an operating state of the gripping module (230) to grip the transport object (B), the first hydraulic module (250) may be operated to move the gripping module (230) in the direction parallel to the first direction facing outward from the accommodation groove (260). In this case, a separated distance between the first gripping module (230a) and the second gripping module (230b) may be longer than the length of the transport object (B) in the horizontal direction.

Thereafter, the control module may control the transport units (21 and 22) so that the suction cup (320) of the suction portion (300) comes into contact with the upper surface of the transport object (B). When the suction cup (320) and the upper surface of the transport object (B) are in contact with each other, the control module may operate the vacuum module (170) to form a vacuum state in an internal space of the suction cup (320). In this manner, the suction portion (300) may fix the transport object (B) by suctioning the transport object (B).

Thereafter, the control module may operate the second hydraulic modules (232a and 233a) so that the gripping member (234a) is located at the second position (P2). In this manner, the third gripping member (234a) of the second hydraulic modules (232a and 233a) may be located at a distance vertically corresponding to the side surface of the transport object (B).

The control module may control the operation of the first hydraulic module (250) so that the first hydraulic shaft (252) moves upward. In this manner, the first gripping module (230a) and the second gripping module (230b) may move in the direction facing the accommodation groove (260), and the third gripping member (234a) may grip the transport object (B) by coming into contact with the side surface of the transport object (B).

Thereafter, the control module may control the transport units (21 and 22) so that the transport object (B) moves to a position corresponding to an instruction of the worker (W). As an example, the corresponding position may be a conveyor (23, refer to FIG. 9) that transports the transport object (B) to another location.

After the transport object (B) moves to the position corresponding to the instruction of the worker (W), the control module may stop the operation of the vacuum module (170). In this manner, the vacuum state inside the suction cup (320) may be released, and the suction between the suction cup (320) and the transport object (B) may be stopped so that the transport object (B) is separated from the suction portion (300).

The control module may operate the first hydraulic pump (251) to move the first hydraulic shaft (252) downward. In this case, the first gripping module (230a) and the second gripping module (230b) may move in a direction opposite to the accommodation groove (260), and the contact between the third gripping member (234a) and the side surface of the transport object (B) may be released. Accordingly, the transport object (B) may be separated from the gripping portion (100).

After the transport object (B) is completely separated from the gripping portion (100), the control module may operate the second hydraulic pump (232a), and may move the second hydraulic shaft (233a) upward so that the gripping member (234a) returns to the first position (P1). The control module may operate the first hydraulic pump (251), and may move the first hydraulic shaft (252) upward so that the first gripping module (230a) and the second gripping module (230b) move to the accommodation groove (260).

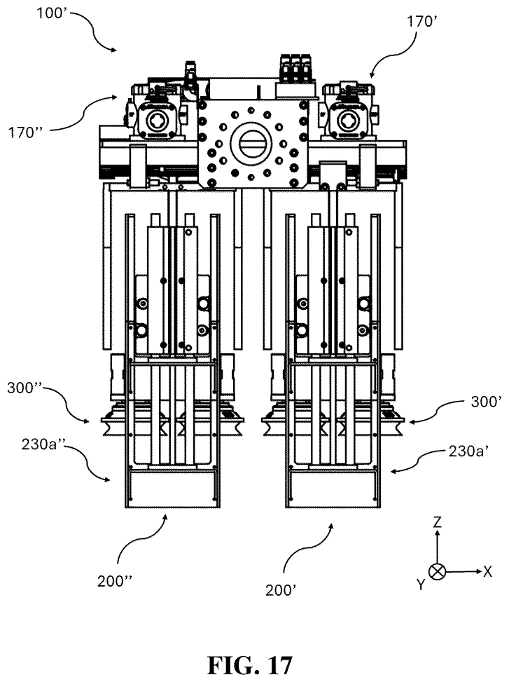

FIG. 17 is a diagram showing a transport device according to one embodiment. Repeated description of the contents will be omitted below.

Referring to FIG. 17, a gripping portion (100′) may include a first gripper assembly (200′) and a second gripper assembly (200″) disposed parallel to the first gripper assembly (200′). Each of the first gripper assembly (200′) and the second gripper assembly (200″) may be coupled to the second fixing body (112). Since a plurality of the gripper assemblies (200′ and 200″) may be provided, the gripping portion (100′) may more stably suction, grip, and transport the transport object (B).

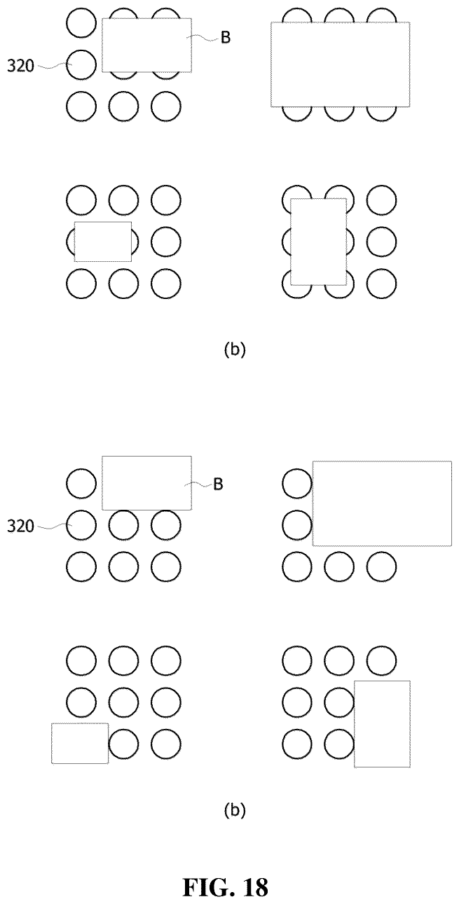

Hereinafter, tilting of the gripping portion (100) will be described with reference to FIGS. 18 to 20.

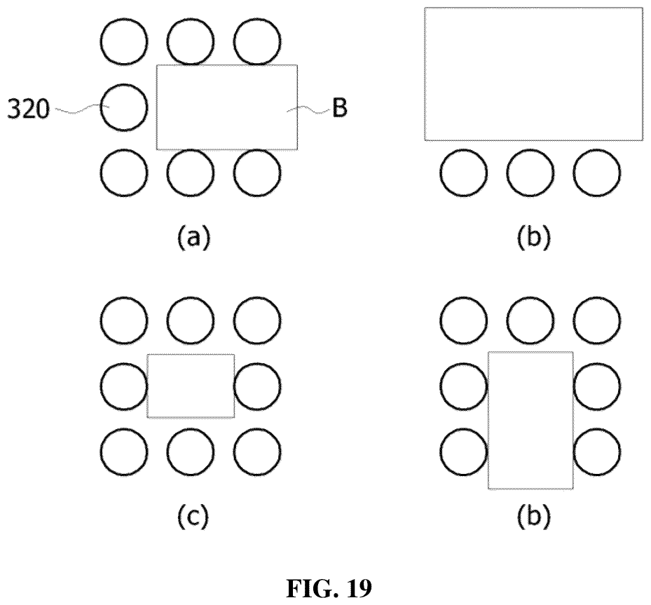

FIG. 18 is a diagram showing examples in which the object is incorrectly fastened by the suction cup of the gripping portion, and FIG. 19 is a diagram showing examples in which the object is correctly fastened by the suction cup of the gripping portion.

The gripping portion (100) is moved by the robot arm, and the suction cups (320) are installed in an n*n row along a bottom surface as shown in FIGS. 18 and 19.

The suction cups (320) are installed in the n*n row along the bottom surface of the gripping portion (100), and fasten the transport object (B) by using a negative pressure.

Here, an angle and a movement degree of the suction cup (320) need to be adjusted by the gripping portion (100) so that only the suction cup capable of suctioning the transport object (B) without exceeding an area of the transport object (B) as shown in FIG. 19 is fastened to the transport object (B).

In one embodiment, the robot arm may move the gripping portion (100) so that the number of the suction cups (320) which are completely seated without being partially detached from the upper surface of the transport object (B) (in cases of (a), (b), and (c) in FIG. 18) is maximized, and the center of gravity of the transport object (B) is brought close to the center of the gripping portion (100) (in cases of (a), (b), (c), and (d) in FIG. 19).

The collision prevention device (2) described above in FIG. 1 may estimate the area of the transport object (B), based on each suction pressure distribution of the plurality of suction cups (320), and may set a collision prevention safety area, based on the area of the transport object (B) based on the pressure distribution.

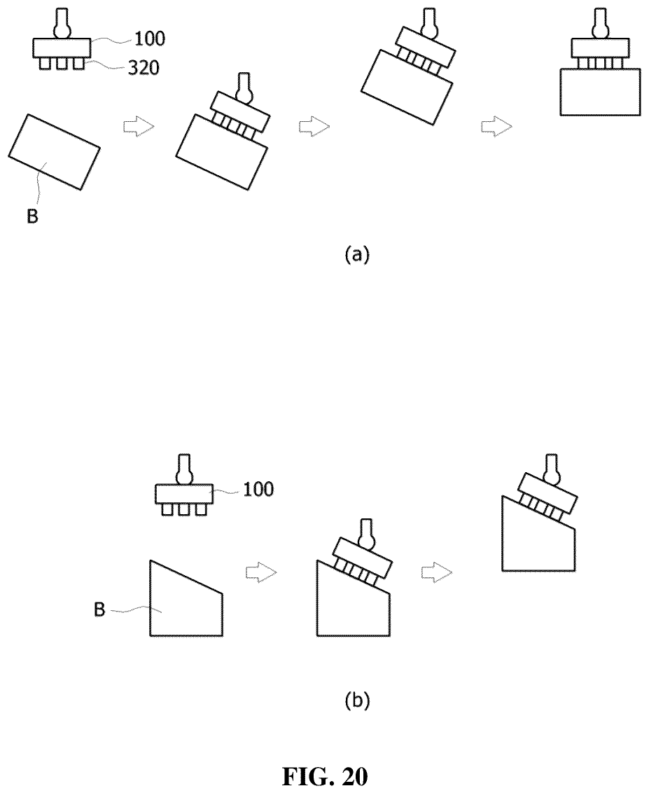

FIG. 20 is a diagram showing examples of methods for fastening the transport object by using the transport robot.

In one embodiment, the robot arm reads the tilting of the transport object (B) as a transport target loaded on the roll container (T) by using the scanning data received from the first identification camera (20) (in a case of (a) of FIG. 20), tilts the gripping portion (100) at the same tilting angle as the tilting angle of the upper surface of the tilted transport object (B), and thereafter, causes the gripping portion (100) to be seated on the transport object (B). After the transport object (B) is fastened, the tilting of the gripping portion (100) is released during the transport process so that the transport object (B) is transported at a normal angle.

In one embodiment, when it is read that a shape of the transport object (B) as a transport target is other than a hexahedron (in the case of (b) of FIG. 12) by using the scanning data received from the first identification camera (20), the robot arm tilts the gripping portion (100) at the same tilting angle as the tilting angle of the upper surface of the transport object (B) having a tilting surface, and thereafter, causes the gripping portion (100) to be seated on the transport object (B). The robot arm releases a fixing state of the gripping portion (100) before the fixing of the suction cup (320). Thereafter, when the transport object (B) is lifted after the fixing of the suction cup (320), the robot arm fixes the tilting of the gripping portion (100) again. In this manner, misalignment of the items contained in the transport object (B) may be prevented.

In one embodiment, in a database form, the robot arm stores a suction limit of the suction cup (320) depending on a weight of the transport object (B) for each tilting angle of the gripping portion (100) (for example, 100 kg for horizontal suction, 50 kg for 30-degree oblique suction, or the like), and may transport the transport objects (B) as the transport targets loaded on the roll container (T) only when the transport object (B) is transportable after identifying each weight distribution of the transport objects (B).

Depending on the weight distribution inside the transport object (B) or a shape or a suction position of the transport object (B), the transport object (B) may tilt due to the center of gravity of the transport object (B) during a lifting process.

For this reason, in order to prevent the tilting of the transport object (B), the transport robot (10) may additionally include a balance device (not shown in the drawing for convenience of description) that fixes the tilting angle after suctioning.

The logistics transport and loading system according to one embodiment of the present disclosure having the above-described configuration may detect the position and the shape of the transport object loaded on the roll container by using the transport robot and the 3D vision system, and thereafter, may automatically transport and load the transport object onto the conveyor. In this manner, the logistics transport and loading system may contribute to a safe and hygienic process, and improved safety and efficiency when the transport object is transported and loaded onto the conveyor.

In addition, the safety of the workers may be ensured, and the logistics may be efficiently managed.

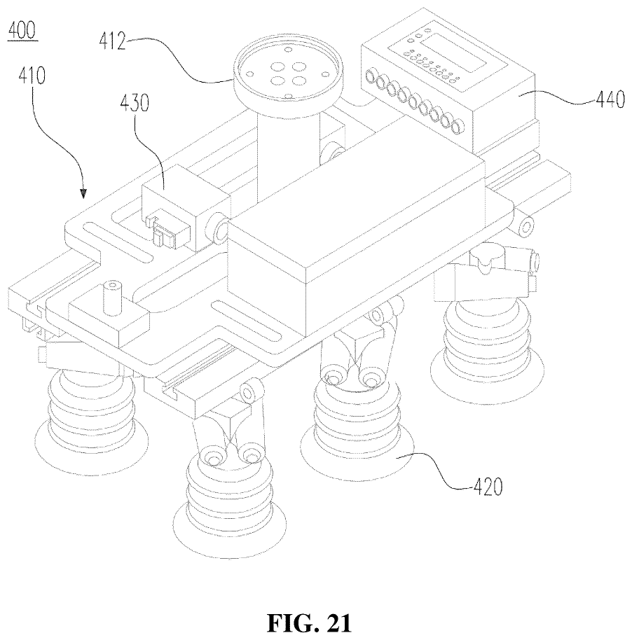

FIG. 21 is a diagram showing a suction gripper in the related art.

Referring to FIG. 21, a suction gripper (400) in the related art includes a gripper body (410), multiple suction units (420), an air control valve (430), and an air pressure switch (440).

The gripper body (410) is installed in an end portion of a collaborative robot, and configurations such as the multiple suction units (420), the air control valve (430), and the air pressure switch (440) are installed therein.

In one embodiment, at least one guide bar for preventing collision with other objects along the periphery is installed in the gripper body (410).

The suction unit (420) is formed in a suction cup shape, and multiple suction units (preferably six units) are provided. The suction unit (420) is installed along a lower side of the gripper body (410), and uses the vacuum formed by the air control valve (430) to fasten the object in a tightly suctioned state.

The air control valve (430) suctions air from the suction unit (420) to form the vacuum.

The air pressure switch (440) senses a level of the negative pressure formed in the suction unit (420), and controls the operation of the air control valve (430).

The above-described embodiments are provided as examples, and those skilled in the art may understand that the above-described embodiments can be easily modified into other specific forms without changing the technical idea or the essential features of the above-described embodiments. Therefore, the above-described embodiments should be understood as illustrative and not restrictive in all respects. For example, respective component described as a single entity may be implemented in a distributed manner, and likewise, components described in the distributed manner may be implemented in a combined manner.

The scope to be protected by the present specification is indicated by the appended claims rather than the detailed description above, and should be interpreted to include all changes or modifications derived from the meaning and the scope of the appended claims and the equivalent concepts.

### REFERENCE SIGNS LIST

1: Logistics transport and loading system
2: Projection device
10: Transport robot
20: First identification camera
30: Second identification camera
100: Gripping portion
200: Gripper assembly
210: Gripper body
230: Gripping module
240: Movement guide
250: First hydraulic module

What is claimed is:

1. A palletizing safety control area setting method implemented to prevent occurrence of safety accidents by displaying a safety area in a projection type around a logistics transport and loading system, the method comprising:
safety area reading for reading the safety area corresponding to a range for preventing a collision with a transport robot forming the logistics transport and loading system to transport and load a transport object or the transport object under transportation and loading, from a safety area reading device; and
safety area displaying for displaying the safety area read in the safety area reading, through projection of a projection device.

2. The palletizing safety control area setting method of claim 1, wherein the safety area reading includes reading the safety area in view of transport object characteristics including a size and a shape of the transport object under transportation after the transport object is picked up by the transport robot.

3. The palletizing safety control area setting method of claim 2, wherein the safety area displaying includes displaying the safety area in view of transport object characteristics read in the safety area reading.

4. The palletizing safety control area setting method of claim 3, wherein the transport object characteristics are read, based on 3D vision recognition using a 3D vision camera.

5. The palletizing safety control area setting method of claim 1, further comprising:
avoidance maneuver area reading for reading an avoidance maneuver area which is an area avoided to prevent the collision by the transport robot when it is determined that the collision with the transport robot or the transport object occurs while the transport object is transported.

6. The palletizing safety control area setting method of claim 5, further comprising:
avoidance maneuver area displaying for displaying the avoidance maneuver area read in avoidance maneuver area reading, through projection of the projection device.

7. The palletizing safety control area setting method of claim 1, further comprising:
area recognizing for recognizing the safety area displayed in the safety area displaying, through vision recognition.

8. The palletizing safety control area setting method of claim 1, further comprising:
probability of falling-down reading for reading a probability of falling-down of the transport object under transportation.

9. The palletizing safety control area setting method of claim 8, wherein the probability of falling-down reading includes reading the probability of falling-down of the transport object fastened to a gripping portion provided in the transport robot in view of at least one factor among a suction pressure distribution of each of a plurality of suction cups installed in an n*n row along a bottom surface of the gripping portion to fasten the transport object by using a position of the center of gravity and a negative pressure of the transport object fastened to the gripping portion, a suction leak degree of the suction cups, and a surface texture of the transport object, and widely setting the safety area as the probability of falling-down is higher in the probability of falling-down reading.

10. The palletizing safety control area setting method of claim 1, further comprising:
avoidance maneuvering for performing a collision avoidance maneuver of the transport robot, when it is determined that there is a probability of collision with the transport robot or the transport object under transportation.
